(19) United States
(12) Patent Application Publication
(10) Pub. No.: US 2012/0297314 A1
(43) Pub. Date: Nov. 22, 2012

(54) SOCIAL INTERACTION TOOLBAR

(75) Inventor: Jeanine Stein, Palo Alto, CA (US)

(73) Assignee: Select2gether, Inc., Menlo Park, CA (US)

(21) Appl. No.: 13/429,152

(22) Filed: Mar. 23, 2012

Related U.S. Application Data
(60) Provisional application No. 61/467,594, filed on Mar. 25, 2011.

(51) Int. Cl. G06F 3/048

(52) U.S. Cl. 715/751

(57) ABSTRACT

Disclosed are systems for interactive social shopping comprising: a digital processing device and a computer program that creates a social shopping toolbar comprising a module adapted to create a selection of items, wherein said items are selected from one or more web sites; and a social shopping web application comprising a module adapted to enable at least a first and a second user to simultaneously view an identical item from said selection of items, such that a live showroom is generated, and a module that enables the first and second user to interact with each other. Also disclosed are methods of creating a social shopping networking service and computer readable media encoded with programs to create the same.

### CROSS REFERENCE TO RELATED APPLICATIONS

This application claims the benefit of U.S. application Ser. No. 61/467,594, filed Mar. 25, 2011, which is hereby incorporated by reference in its entirety.

### BACKGROUND OF THE INVENTION

Approximately 2 billion people, or roughly 30% of the world's population use the Internet. Over the last decade, this group has grown by over 400%. Among other activities, many use the World Wide Web for shopping. According to the Census Bureau, in the first quarter of 2010, unadjusted U.S. retail e-sales were $36.6 billion for the quarter, on track for yearly e-sales of $146 billion.

### SUMMARY OF THE INVENTION

Most activities performed on the web, including learning and researching, staying informed of news and current events, working, dating, and shopping, can be characterized as solitary. For example, users experience online shopping alone, browsing pages, viewing and comparing items, and making purchases, essentially by themselves. Increasingly, technology offers new opportunities to create more social and collaborative computer-based activities. By way of example, social shopping is e-commerce in which shoppers' friends and advisors become involved in the shopping experience. Social shopping uses technology to mimic the social interactions found in physical malls, stores, salons, and boutiques.

Disclosed herein, in certain embodiments, are systems for computer-based social interaction, comprising: a digital processing device comprising an operating system configured to perform executable instructions and a memory, wherein the processing device is optionally connected to a computer network; and a computer program including executable instructions that create a social interaction networking service comprising: a social interaction toolbar comprising a module adapted to create a selection of items, wherein said items are selected from one or more web sites; and a social interaction web application comprising a module adapted to enable at least a first and a second user to simultaneously view an identical item from said selection of items, such that a live showroom is generated, and a module that enables the first and second user to interact with each other. In some embodiments, the toolbar comprises a functional addition to a web browser such as a plug-in, extension, add-in, or add-on. In further embodiments, the toolbar comprises a functional addition to a mobile web browser such as a plug-in, extension, add-in, or add-on. In some embodiments, the toolbar comprises a mobile application. In some embodiments, the toolbar comprises a standalone application. In some embodiments, the toolbar is available to a user when viewing any web site. In further embodiments, the toolbar is available to a user when viewing, for example, educational sites, news sites, travel sites, real estate sites, dating sites, and shopping sites. In some embodiments, the items in the selection of items include text, photographs, illustrations, videos, multimedia, hyperlinks, or any combination thereof. In some embodiments, the toolbar further comprises a module adapted to export one or more items from said selection of items to said social interaction web application. In further embodiments, the toolbar further comprises a module adapted to export one or more items from said selection of items to a third party social network. In some embodiments, the selection of items comprises graphic representations, such as photographs, of the items. In some embodiments, the selection of items further comprises Uniform Resource Identifiers (URIs) of the items. In additional embodiments, the module adapted to create a selection of items generates additions to the selection of items by analyzing the previous items selected by a user. In some embodiments, the toolbar further comprises a module adapted to search items previously selected by one or more users from one or more web sites. In some embodiments, the toolbar further comprises a module adapted to monitor the online status of one or more friends or advisors. In further embodiments, the friends or advisors are other users of the social interaction networking service. In still further embodiments, the friends or advisors are users of a third party social network. In some embodiments, the toolbar further comprises a module adapted to query one or more friends or advisors regarding one or more items from a selection of items. In some embodiments, the toolbar further comprises a module adapted to exchange information with said web application. In some embodiments, the module that enables the first and second user to interact with each other is configured to enable one or more interactions including, by way of non-limiting examples, email, chat, instant messaging, SMS, MMS, blogging, microblogging, BBS posts, social networking, wall posts, screen sharing, video conferencing, and VoIP. In further embodiments, a live discussion room is created. In other embodiments, a live showroom is created.

Disclosed herein, in certain embodiments, are computer readable storage media encoded with a program including instructions executable by the operating system of an optionally networked digital processing device, wherein said instructions create a social shopping networking service comprising: a social shopping toolbar comprising a module adapted to create a selection of items, wherein said items are selected from one or more web sites; and a social shopping web application comprising a module adapted to enable at least a first and a second user to simultaneously view an identical item from said selection of items, such that a live showroom is generated, and a module that enables the first and second user to interact with each other.

Disclosed herein, in certain embodiments, are computer-implemented methods for creating a social shopping networking service, comprising: providing a first user with a computer program including executable instructions that create a social shopping toolbar comprising a module adapted to create a selection of items from one or more web sites; and providing said first user and at least a second user with a computer program including executable instructions that create a social shopping web application comprising a module adapted to simultaneously view an identical item from said selection of items, such that a live showroom is generated, and a module that enables said users to interact with each other. Also disclosed here, in certain embodiments, are computer-implemented methods for making a web-based purchase, comprising: a first user creating a selection of items from one or more web sites using a social shopping toolbar; said first user querying at least a second user regarding one or more items from said selection of items using said toolbar; said first user and at least said second user simultaneously viewing one or more items from said selection of items using a social shopping web application, such that a live showroom is generated, wherein said toolbar exchanges data with said web application; and any of the users purchasing one or more of said items. In some embodiments, the first user selects one or more items by dragging an element of the toolbar and dropping it over an item. In other embodiments, the first user selects one or more items by dragging an item to an element of the toolbar. In some embodiments, the first user selects one or more items by specifying a graphic representation to upload. In other embodiments, the first user selects one or more items by typing a URI. In various embodiments, the selection of items comprises up to 200, 150, 100, 50, 25, 10, or 5 items at any given time. In some embodiments, the first user initiates the interaction between users by querying at least a second user regarding one or more items from said selection of items. In further embodiments, queried users receive a message inviting them to view one or more selected items and interact.

### BRIEF DESCRIPTION OF THE DRAWINGS

FIG. 1 shows a non-limiting example of a social interaction toolbar; in this case, a social shopping toolbar including a module adapted to create a selection of items from one or more web sites.

FIG. 2 shows a non-limiting example of a social interaction toolbar; in this case, a social shopping toolbar available to a user when viewing any web site including a retail shopping web site.

FIG. 3 shows a non-limiting example of a module adapted to create a selection of items; in this case, a module adapted to export one or more items from said selection of items to said social interaction web application.

FIG. 4 shows a non-limiting example of a module adapted to create a selection of items; in this case, a module further adapted to delete selected items.

FIG. 5 shows a non-limiting example of a module adapted to create a selection of items; in this case, a module further adapted to upload photos of selected items.

FIG. 6 shows a non-limiting example of a module adapted to monitor the online status of one or more friends or advisors; in this case, a module further adapted to monitor friends from a third party social network.

FIG. 7 shows a non-limiting example of a module adapted to query one or more friends or advisors regarding one or more items from a selection of items; in this case, a module further adapted to initiate a live interaction.

FIG. 8 shows a non-limiting example of a social shopping web application; in this case, a web application further comprising a module adapted to query one or more friends or advisors regarding one or more items from a selection of items.

FIG. 9 shows a non-limiting example of a social shopping web application; in this case, a web application further comprising a module adapted to optionally query one or more friends or advisors with specific pre-configured questions regarding one or more items from a selection of items.

FIG. 10 shows a non-limiting example of a module adapted to query one or more friends or advisors regarding one or more items from a selection of items; in this case, a module further adapted to display a message to one or more friends or advisors.

FIG. 11 shows a non-limiting example of a module adapted to query one or more friends or advisors regarding one or more items from a selection of items; in this case, a module further adapted to query other users of the social shopping networking service or a third party social network and initiate a live interaction.

FIG. 12 shows a non-limiting example of a social shopping web application; in this case, an application comprising a module adapted to enable a plurality of users to simultaneously view an identical item from a selection of items, such that a live showroom is generated.

FIG. 13 shows a non-limiting example of a module adapted to search items previously selected by one or more users from one or more web sites; in this case, a module wherein search results are sortable by type of item, brand, discount, or description.

### DETAILED DESCRIPTION OF THE INVENTION

As used herein, “graphic user interface” means the system by which a user interacts with a computer, a server, a program, an application, a web site, a social networking service, a social shopping networking service, a social shopping toolbar, a social shopping web application, or a combination thereof.

The terms “items,” “items for purchase,” “products,” “merchandise,” and “services” may be used interchangeably. Items include, by way of non-limiting examples, apparel (e.g., intimates, clothing, outerwear, and shoes), apparel accessories (e.g., hats, gloves, fragrances, purses, bags, and jewelry), electronic equipment (e.g., televisions, DVD players, CD players, MP3 players, phones, GPS navigation systems, and cameras), art, furniture, home decor, books, cars, travel, real property, news articles, wiki articles, dating profiles, etc. Items for purchase are either new or used. The items described herein are available on the Internet or the World Wide Web. Where items are for purchase, they are offered for sale by vendors or merchants (e.g., Amazon.com) or individuals (e.g., individuals on eBay).

As used herein, “shopping” means viewing items, comparing items, discussing product and service information with others, as well as purchasing products and services.

As used herein, “sales representative” and “salesperson” mean an individual working for a vendor.

As used herein, an “advisor” is a third party expert, affiliated, or not affiliated, with one or more providers of information, products, or services. In some embodiments, a product advisor provides general information to a customer about a commercial product or service and similar, competing products or services.

As used herein, “third party social network” means an online service, platform, or web site that focuses on building and reflecting of social networks or social relations among people, e.g., who share interests and/or activities. Non-limiting examples of such networks include, Badoo, Bebo, Blogster, Buzzfeed, CafeMom, Classmates.com, Cyworld, Decayenne, Delicious, DeviantART, Digg, Diglo, Facebook, FARK, Flixster, Flickr, Fotolog, Foursquare, Friendfeed, Friends Reunited, Friendster, Google+, Habbo, hi5, iWiW, LinkedIn, Livejournal, Meetup, Mixi, Multiply, Mylife, Myspace, MyYearbook, Netlog, Nexopia, Ning, Orkut, PerfSpot, Pingsta, Pinterest, Plaxo, Reddit, renren, Slashdot, Skyrock, SoundCloud, StudiVZ, Stumbleupon, Tagged, Tuenti, Tumblr, Tweetmeme, Twitter, Wretch, XING, Yammer, Yelp, Zorpia, and the like.

Existing education, news, travel, real estate, dating, and e-commerce systems and methods fail to offer adequate social interaction and collaboration. Thus, a primary objective of the social interaction systems, products, and programs, and methods for creating the same disclosed herein is to bring online experiences, for example, the online shopping experience, closer to real shopping experiences, wherein participants query and interact with sales persons, friends, and advisors. Another objective of the social interaction systems, products, and programs, and methods for creating the same disclosed herein is to provide a social interaction toolbar that is available to users at all times from any web site. A further objective is to integrate friends and advisors from third party social networks.

Disclosed herein, in various embodiments, are systems for computer-based social interaction, comprising: a digital processing device comprising an operating system configured to perform executable instructions and a memory, wherein said processing device is optionally connected to a computer network; and a computer program including executable instructions that create a social interaction networking service comprising: a social interaction toolbar comprising a module adapted to create a selection of items, wherein said items are selected from one or more web sites; and a social interaction web application comprising a module adapted to enable at least a first and a second user to simultaneously view an identical item from said selection of items, such that a live showroom is generated, and a module that enables the first and second user to interact with each other.

Also disclosed herein, in various embodiments, are computer readable storage media encoded with a program including instructions executable by the operating system of an optionally networked digital processing device, wherein said instructions create a social shopping networking service comprising: a social shopping toolbar comprising a module adapted to create a selection of items, wherein said items are selected from one or more web sites; and a social shopping web application comprising a module adapted to enable at least a first and a second user to simultaneously view an identical item from said selection of items, such that a live showroom is generated, and a module that enables the first and second user to interact with each other.

Additionally disclosed herein, in various embodiments, are computer-implemented methods for creating a social shopping networking service, comprising: providing a first user with a computer program including executable instructions that create a social shopping toolbar comprising a module adapted to create a selection of items from one or more web sites; and providing said first user and at least a second user with a computer program including executable instructions that create a social shopping web application comprising a module adapted to simultaneously view an identical item from said selection of items, such that a live showroom is generated, and a module that enables said users to interact with each other.

Additionally disclosed here, in various embodiments, are computer-implemented methods for making a web-based purchase, comprising: a first user creating a selection of items from one or more web sites using a social shopping toolbar; said first user querying at least a second user regarding one or more items from said selection of items using said toolbar; said first user and at least said second user simultaneously viewing one or more items from said selection of items using a social shopping web application, such that a live showroom is generated, wherein said toolbar exchanges data with said web application; and any of the users purchasing one or more of said items.

### Social Interaction Networking Service

The systems, products, programs, and methods for computer-based social interaction described herein include a computer program with executable instructions that create a social interaction networking service. In some embodiments, the social interaction networking service includes a social interaction toolbar. In some embodiments, the social interaction networking service includes a social interaction web application. In further embodiments, the social interaction networking service, the toolbar, the web application, and/or other components of the service are adapted to integrate and exchange information with each other. In still further embodiments, the social interaction networking service, the toolbar, and/or the web application exchange information with third party web sites. In still further embodiments, the social interaction networking service, the toolbar, the web application, and/or other components exchange information with social networks. In some embodiments, the social interaction is online shopping.

### Digital Processing Device

The systems, products, programs, and methods described herein include a digital processing device. The digital processing device includes one or more hardware central processing units (CPU) that carry out the device's functions. The digital processing device further comprises an operating system configured to perform executable instructions. In some embodiments, the digital processing device further comprises a memory device, a display, an input device, and optionally a sound output device. In some embodiments, the digital processing device is connected to the Internet such that it accesses the World Wide Web. In other embodiments, the digital processing device is connected to an intranet. In other embodiments, the digital processing device is connected to a data storage device. In some embodiments, the digital processing device is a non-portable device, such as a server or a desktop computer. In other embodiments the digital processing device is a portable device, such as a laptop or tablet computer. In other embodiments the digital processing device is a mobile device, such as a smartphone or digital music player.

The digital processing device includes an operating system configured to perform executable instructions. The operating system is, for example, software, including programs and data, which manages the device's hardware and provides services for execution of applications. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the digital processing device includes a storage and/or memory device. A storage and/or memory device is one or more physical apparatuses used to store data or programs on a temporary or permanent basis. In some embodiments, a memory device is volatile memory and requires power to maintain stored information. In some embodiments, a memory device is non-volatile memory and retains stored information when the digital processing device is not powered. In further embodiments, a non-volatile memory comprises flash memory. In some embodiments, a non-volatile memory comprises dynamic random-access memory (DRAM). In some embodiments, a non-volatile memory comprises ferroelectric random access memory (FRAM). In some embodiments, a non-volatile memory comprises phase-change random access memory (PRAM). In other embodiments, a memory device is a storage device including, by way of non-limiting examples, CD-ROMs, DVDs, flash memory devices, magnetic disk drives, magnetic tapes drives, optical disk drives, and cloud computing based storage. In further embodiments, a storage and/or memory device is a combination of devices such as those disclosed herein.

In some embodiments, the digital processing device includes a visual display. In some embodiments, a display is a cathode ray tube (CRT). In some embodiments, the display is a liquid crystal display (LCD). In further embodiments, a display is a thin film transistor liquid crystal display (TFT-LCD). In some embodiments, a display is an organic light emitting diode (OLED) display. In various further embodiments, an OLED display is a passive-matrix OLED (PMOLED) or active-matrix OLED (AMOLED) display. In some embodiments, a display is a plasma display. In other embodiments, a display is a video projector. In still further embodiments, a display is a combination of devices such as those disclosed herein.

In some embodiments, the digital processing device includes an input device. In some embodiments, the input device is a keyboard or keypad. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the digital processing device optionally includes a sound output device. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices such as those disclosed herein.

In accordance with the description provided herein, suitable digital processing devices include, by way of non-limiting examples, server computers, desktop computers, laptop computers, notebook computers, tablet computers, netbook computers, smartbook computers, subnotebook computers, ultra-mobile PCs, handheld computers, personal digital assistants, Internet appliances, smartphones, music players, and portable video game systems. Those of skill in the art will recognize that many mobile smartphones are suitable for use in the system described herein. Suitable tablet computers include those with booklet, slate, and convertible configurations, known to those of skill in the art. Suitable portable video game systems include, by way of non-limiting examples, Nintendo DS™ and Sony® PSP™.

### Computer Network

The systems, products, programs, and methods disclosed herein include a digital processing device that is optionally connected to a computer network. A computer network is a collection of computers and/or devices interconnected by communications channels that facilitate communications among users and allow users to share resources. In view of the disclosure provided herein, the computer network is created by techniques known to those of skill in the art using hardware, firmware, and software known to the art. In some embodiments, the computer network is a private network such as an intranet. In some embodiments, the computer network is the Internet. In further embodiments, the Internet provides access to the World Wide Web and the computer program and/or mobile application is provided to the digital processing device via the Web. In still further embodiments, the Internet provides access to the World Wide Web and the computer program and/or mobile application is provided to the digital processing device via cloud computing. In other embodiments, the computer network comprises data storage devices including, by way of non-limiting examples, CD-ROMs, DVDs, flash memory devices, solid state memory, magnetic disk drives, magnetic tape drives, optical disk drives, cloud computing systems and services, and the like. In further embodiments, the computer program and/or mobile application is provided to the digital processing device via a data storage device.

### Computer Readable Storage Medium

In some embodiments, the systems, products, programs, and methods disclosed herein include one or more computer readable storage media encoded with a program including instructions executable by the operating system of an optionally networked digital processing device, wherein said instructions create a social shopping networking service. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

The systems, products, programs, and methods disclosed herein include at least one computer program. The computer program includes a sequence of instructions, executable in the digital processing device's CPU, written to perform a specified task. Those of skill in the art will recognize that the computer program may be written in various versions of various languages. In some embodiments, the computer program comprises one sequence of instructions. In some embodiments, the computer program comprises a plurality of sequences of instructions. In some embodiments, the computer program is delivered from one location. In other embodiments, the computer program is delivered from a plurality of locations. In various embodiments, the computer program comprises, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In view of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. In view of the disclosure provided herein, those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, or Tcl. In some embodiments, a web application is written to some extent in a database query language such as Structured Query Language (SQL).

### Mobile Application

In some embodiments, the computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, the mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Those of skill in the art will also recognize that mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, the computer program includes a standalone application, which is a program that is run as an independent computer process, not an add-on to an existing process, e.g. not a plug-in. Those of skill in the art will recognize that standalone applications are often compiled. A compiler is a computer program(s) that transforms source code written in a programming language into binary object code such assembly language or machine code. Suitable compiled programming languages include, by way of non-limiting examples, C, C++, Objective-C, COBOL, Delphi, Eiffel, Java™, Lisp, Visual Basic, and VB .NET, or combinations thereof. Compilation is often performed, at least in part, to create an executable program. In some embodiments, the computer program includes one or more executable complied applications.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Social Interaction Toolbar

In some embodiments, the computer program creates a social networking service that includes a social interaction toolbar. A toolbar is a graphic user interface (GUI) element comprising, by way of non-limiting examples, onscreen text, images, icons, buttons, checkboxes, menus, text fields, or other input or output elements. Those of skill in the art will recognize that toolbars are found in a wide range of applications including office suites, graphics editors, web browsers, and the like. In some embodiments, the toolbar comprises a web browser plug-in, extension, add-in, or add-on. In other embodiments, the toolbar comprises a mobile application. In still other embodiments, the toolbar comprises a standalone application.

In some embodiments, the social interaction toolbar comprises a module adapted to create a selection of items, wherein said items are selected from one or more web sites.

In various embodiments, the social interaction toolbar facilitates interaction regarding any items of interest to a user and comprises a module adapted to create a selection of items selected from any web site. In further embodiments, the social interaction toolbar is a social shopping toolbar and comprises a module adapted to create a selection of items for purchase, wherein said items are selected from one or more shopping web sites. In other embodiments, the social interaction toolbar is a social learning toolbar and comprises a module adapted to create a selection of educational items, wherein said items are selected from one or more education web sites. In other embodiments, the social interaction toolbar is a social news toolbar and comprises a module adapted to create a selection of news items, wherein said items are selected from one or more news web sites. In other embodiments, the social interaction toolbar is a social travel toolbar and comprises a module adapted to create a selection of educational items, wherein said items are selected from one or more education web sites. In other embodiments, the social interaction toolbar is a social dating toolbar and comprises a module adapted to create a selection of dating profiles, wherein said items are selected from one or more dating web sites.

In various embodiments, items are represented by text, hyperlinks (e.g., URI), photographs, illustrations, videos, multimedia, or any combination thereof. In further embodiments, one or more items are represented by text. Many text formats are suitable including, by way of non-limiting examples, Rich Text Format (RTF), TXT, HTML, and XHTML formatted text.

In some embodiments, one or more items are represented by a graphic representation. In further embodiments, the graphic representation of one or more items is a photograph. See FIGS. 2, 3, 4, 7, 8, 9, 10, 11, 12, and 13. In some embodiments, the graphic representation of one or more items an illustration. In some embodiments, the graphic representation is a 3-dimensional graphic representation. In some embodiments, the graphic representation is a 2-dimensional graphic representation. In some embodiments, the graphic representation further comprises a graphic representation (e.g., avatar) of one or more users of the system. Suitable graphics formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP.

In some embodiments, one or more items are represented by a video. Many video formats are suitable including, by way of non-limiting examples, AVI, MPEG, Apple® QuickTime®, MP4, AVCHD®, Windows Media®, DivX™, Flash Video, Ogg Theora, WebM, and RealMedia.

In some embodiments, one or more items are represented by an audio file. Many audio formats are suitable including, by way of non-limiting examples, MP3, WAV, AIFF, AU, Apple® Lossless, MPEG-4, Windows Media®, Vorbis, AAC, and Real Audio®.

In some embodiments, one or more items are represented by a multimedia file, such as an interactive element, a game, and the like. Many multimedia formats are suitable including, by way of non-limiting examples, Adobe® Flash®, Apple® QuickTime®, Microsoft® Silverlight®, Java™ HTML 5, XHTML 5, and Unity®.

In other embodiments, one or more items are represented by a combination of the files, formats, and media disclosed herein. In further embodiments, a combination of files, formats, and media is, for example, an article, a brochure, a book, a web page, a web site, or parts thereof. In some embodiments, each item is associated with a text description. In some embodiments, the description comprises, by way of non-limiting examples, manufacturer, designer, vendor, provider, author, materials used to make the item, a manual describing how to use the item, color options, size options, or combinations thereof. In some embodiments, the description further comprises a module that enables a user to request additional information about the item. In some embodiments, each item is associated with a URI.

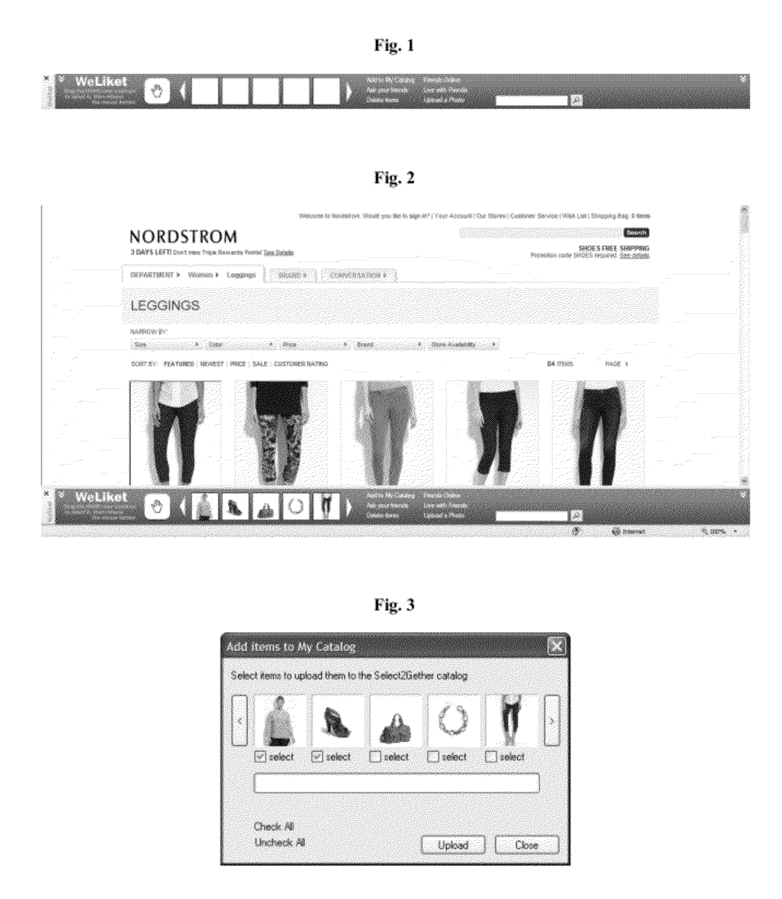

Referring to FIG. 1, in some embodiments, the toolbar is expandable and collapsible. In some embodiments, the toolbar is removable (e.g., closable) and restorable (e.g., re-openable). In some embodiments, the toolbar has GUI elements for searching for items for purchase, observing the online status of others, and interacting with others with regard to one or more items for purchase. In some embodiments, the social shopping toolbar includes a module adapted to create a selection of items from one or more web sites. In a particular embodiment, a user selects one or more items (e.g., represented by text, photograph, illustration, video, or a combination of the same) from one or more web sites by dragging an element of the toolbar (e.g., a hand icon, a crosshairs, an arrow, etc.) and dropping it over an item.

In other embodiments, a user selects one or more items (e.g., represented by text, photograph, illustration, video, or a combination of the same) by dragging an item to an element of the toolbar. In other embodiments, a user selects one or more items by typing a URI associated with each item. In various embodiments, the selection of items comprises up to 200, 190, 180, 170, 160, 150, 140, 130, 120, 110, 100, 90, 80, 70, 60, 50, 40, 30, 20, 10, 9, 8, 7, 6, 5, 4, 3, or 2, items at any given time, including increments therein. In further embodiments, a user scrolls through a plurality of items by using arrow buttons, keyboard keys, or scroll bars.

Referring to FIG. 2, in some embodiments, the toolbar is anchored to the GUI of a web browser in such a way that it is available to a user when viewing any web site at any time. In further embodiments, the toolbar is detachable from the GUI of a web browser. In further embodiments, the toolbar floats over web site content. In some embodiments, the toolbar is expanded and/or collapsed by mouse click, touchscreen tap, touchscreen swipe, or keystroke to coordinate efficient use of screen real estate when shopping online.

Referring to FIG. 3, in some embodiments, the toolbar further includes a module adapted to export one or more items from said selection of items to the social shopping web application. In a particular embodiment, the module is activated by a button or link on the toolbar and includes a scrollable list of selected items and checkboxes used to indicate items for export. In view of the disclosure herein, those of skill in the art will recognize that computer technologies offer many other ways to enable a user to indicate one or more items.

In some embodiments, the toolbar further includes a module adapted to export one or more items (e.g., represented by text, photograph, illustration, video, or a combination of the same) from said selection of items to a third party social network, social application, shopping forum, or communications forum. In further embodiments, the module exports one or more items to Facebook, MySpace, Blogger, Delicious, Digg This, Google, Google+, Kaboodle, LinkedIn, Microsoft Live, Plaxo, Propeller, Reddit, StumbleUpon, Tweet This, AIM, AIM Share, Amazon, Ask, Backflip, Bebo, Blogmarks, Buzz, Diigo, Fark, Faves, Friendfeed, kRISTY, Link-a-Gogo, Mister Wong, Mixx, Multiply, myAOL, Netvibes, Netvouz, Newsvine, Pinterest, Simpy, Slashdot, Spurl, Stylehive, Technorati, Thisnext, Tumblr, TypePad, WordPress, and/or Y!Bookmarks.

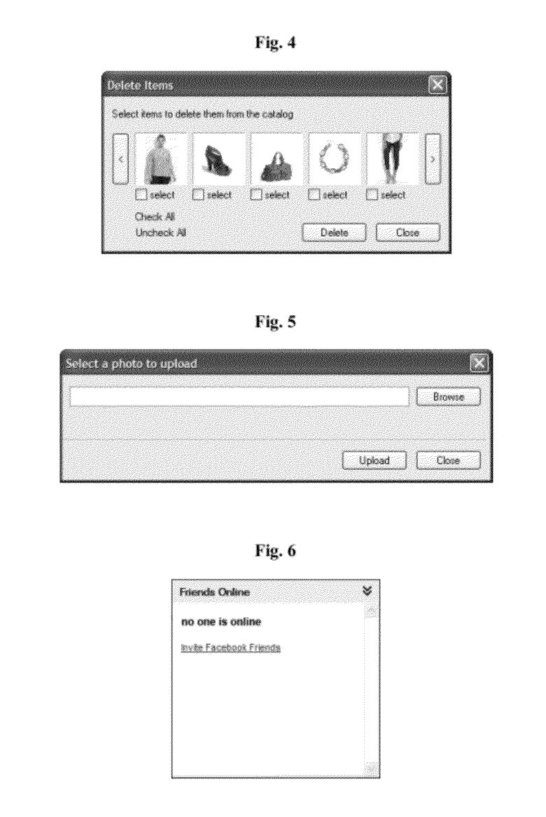

Referring to FIG. 4, in some embodiments, the toolbar includes a module adapted to create a selection of items that is further adapted to delete selected items. In a particular embodiment, the module is activated by a button or link on the toolbar and includes a scrollable list of selected items and checkboxes used to indicate items for deletion. In view of the disclosure herein, those of skill in the art will recognize that computer technologies offer many other ways to enable a user to indicate one or more items.

Referring to FIG. 5, in some embodiments, the toolbar includes a module adapted to create a selection of items that is further adapted to upload photos of selected items. In further embodiments, the photo is uploaded from a storage device connected to the digital processing device. In other embodiments, the photo is uploaded from, by way of non-limiting examples, the Internet, the web, the cloud, an intranet, a camera, or a phone. In some embodiments, the module is activated by a button or link on the toolbar and a user indicates photos for upload typing or browsing for a URI, filepath, or filename.

Referring to FIG. 6, in some embodiments, the toolbar includes a module adapted to monitor the online status of one or more friends or advisors. In a particular embodiment, the module is activated by a button or link on the toolbar and allows a user to monitor the online status of other users of the system described herein and/or users of a third party social network such as those described herein. In some embodiments, friends or advisors who are currently online are represented by a graphic representation (e.g., a photo or avatar) and or a name or screen name.

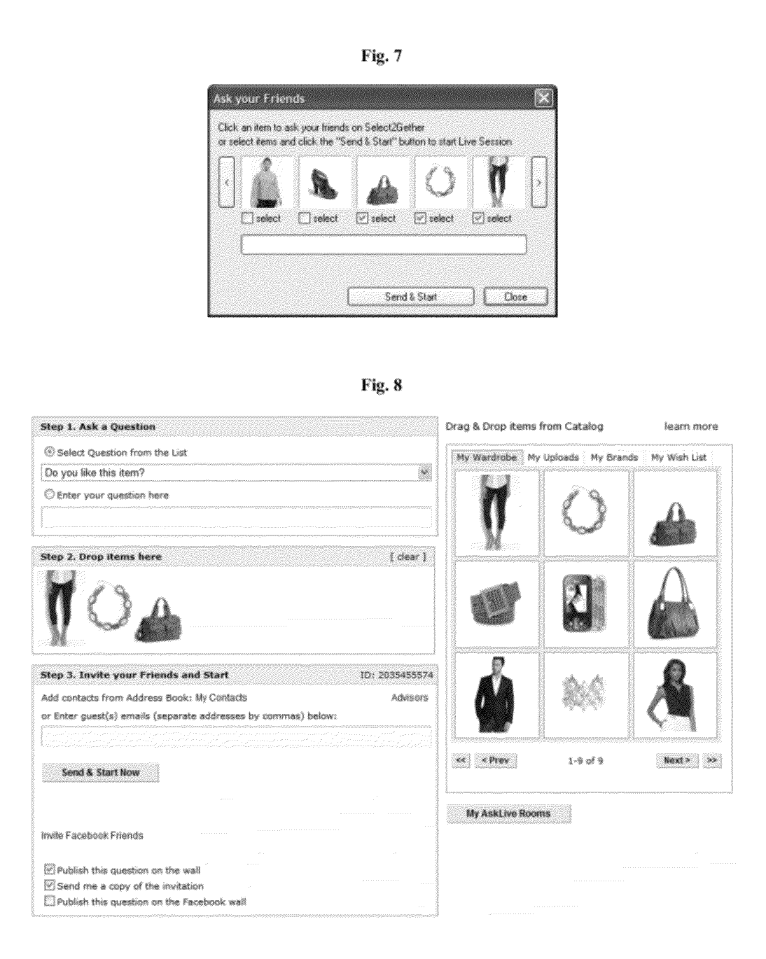

Referring to FIG. 7, in some embodiments, the toolbar includes a module adapted to query one or more friends or advisors regarding one or more items from a selection of items. In a particular embodiment, the module is activated by a button or link on the toolbar and includes a scrollable list of selected items and checkboxes used to indicate items for query. In view of the disclosure herein, those of skill in the art will recognize that computer technologies offer many other ways to enable a user to indicate one or more items. In further embodiments, the module is further adapted to initiate a live interaction. In still further embodiments, the module is further adapted to initiate a live interaction with one or more friends or advisors within a social shopping web application.

### Social Interaction Web Application

In some embodiments, the computer program creates a social interaction networking service that includes a social interaction web application. In further embodiments, the social interaction web application comprises a module adapted to enable at least a first and a second user to simultaneously view an identical item from a selection of items (e.g., represented by text, photograph, illustration, video, or a combination of the same), such that a live discussion room is generated. In some embodiments, the social interaction web application comprises a module adapted to enable the first and second user to interact with each other. In further embodiments, the computer program creates a social shopping networking service that includes a social shopping web application. In further embodiments, the social shopping web application comprises a module adapted to enable at least a first and a second user to simultaneously view an identical item for purchase from a selection of items, such that a live showroom is generated. In still further embodiments, a module adapted to enable at least a first and a second user to simultaneously view an identical item allows at least a first and a second user to view a photograph or illustration together, watch a video together, or read an article together. In some embodiments, the social shopping web application comprises a module adapted to enable the first and second user to interact with each other. In further embodiments, a module adapted to enable the first and second user to interact with each other allows at least a first and a second user to exchange text, photos, illustrations, videos, or content comprising combinations of the same.

In some embodiments, the interactive social shopping user interface connects a first user and at least a second user to the social shopping networking service. In some embodiments, the first user and the second user are members of the social shopping networking service (e.g., establishes a personal account with a log-in and a password). In some embodiments, the first user and the second user are guests (e.g., non-registered users) of the social shopping networking service.

In some embodiments, the first or the second user is: a vendor representative, a personal shopper, a sales consultant, a stylist, a friend, or a combination thereof. In some embodiments, the first or the second user is a vendor representative. In some embodiments, the first or the second user is a personal shopper. In some embodiments, the first or the second user is a sales consultant. In some embodiments, the first or the second user is a stylist. In some embodiments, the first or the second user is a layperson (e.g., a person that is not professionally involved in shopping).

In some embodiments, the first user or the second user is a sales representative or product advisor. In some embodiments, the sales representative or product advisor is asked to join a chat session or interactive session by inviting them from a group of friends, by using a hyperlink from a vendor's web site, or by using a hyperlink that offers names of third party vendors. In some embodiments, if a sales representative or advisor is not available, the user clicks on their name sends them a communication (e.g., a non-real time communication) asking for product information.

In some embodiments, a user selects other users with whom to interact. In some embodiments, a user searches for another user. In some embodiments, the social shopping networking service suggests connections between users.

In some embodiments, the first user or the second user invites a contact to join the social interaction networking service. In some embodiments, a user of the social shopping network invites a contact from a third party social network, such as those described herein, to launch the interactive social shopping interface. In some embodiments, the contact is imported from an electronic address book associated with the operating system of the digital processing device. In some embodiments, the contact is associated with a communications application (e.g., Microsoft Outlook, Apple Mail, Gmail, Yahoo mail, hotmail, AOL email, and the like).

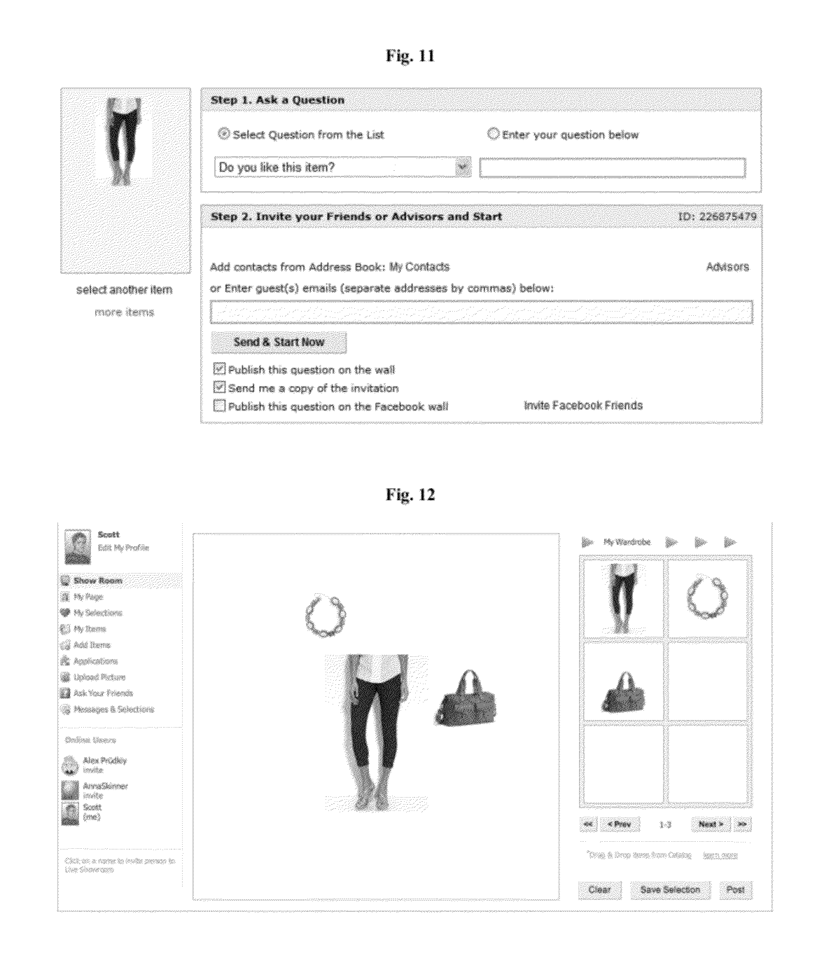

Referring to FIGS. 8 and 11, in some embodiments, the web application further comprises a module adapted to query one or more contacts regarding one or more items from a selection of items. In some embodiments, the toolbar provides access to the module. In further embodiments, the module is activated by a button or link on the toolbar. In some embodiments, the contact or contacts are friends or advisors as each is described herein.

In some embodiments, the module adapted to query one or more contacts regarding one or more items from a selection of items allows a user to ask a question about one or more items. In further embodiments, a user types one or more questions. In some embodiments, the module allows a user to identify one or more items from the selection of items. In various embodiments, a user identifies items with actions including, by way of non-limiting examples, clicking or tapping one or more items, dragging and dropping one or more items, or manipulating buttons or checkboxes associates with one or more items. In some embodiments, the module allows a user to identify contacts to receive the query. In further embodiments, a user identifies contacts by typing identifying information including, by way of non-limiting examples, email addresses, phone numbers, names, and screen names. In still further embodiments, a user identifies contacts by importing identifying information from, by way of non-limiting examples, an address book, an email application, and a third party social network. In some embodiments, the query is posted on a wall or bulletin board. In other embodiments, the query is sent by communications including, by way of non-limiting examples, email, instant message, SMS, MMS, voicemail, video conferencing, or VoIP. In some embodiments, the query initiates simultaneous viewing of an identical item from said selection of items, such that a live showroom is generated. In some embodiments, the query initiates interaction between two or more users.

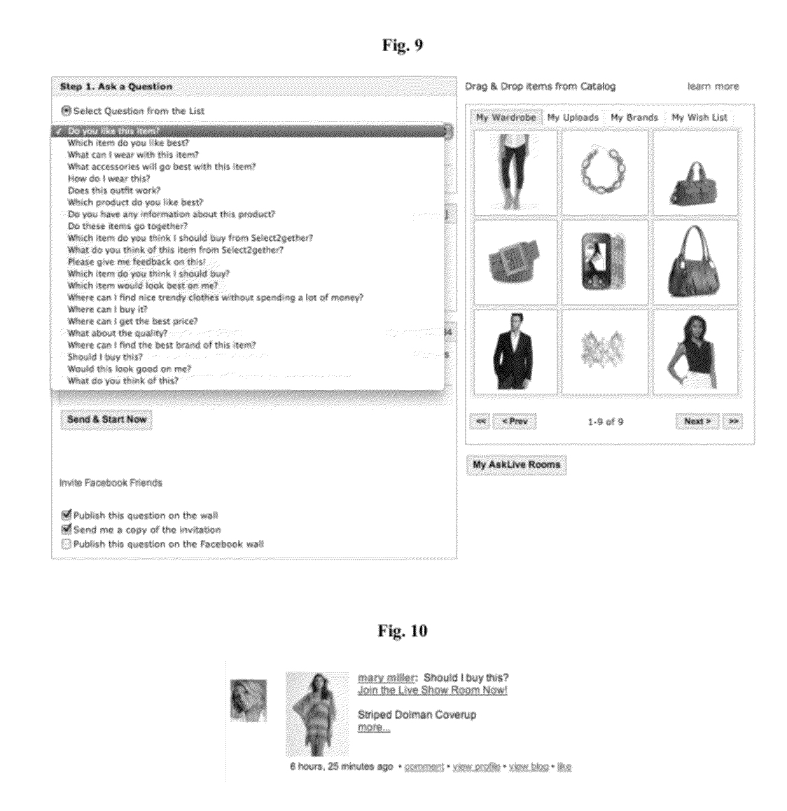

Referring to FIG. 9, in some embodiments, the module adapted to query one or more contacts regarding one or more items from a selection of items allows a user to ask a question about one or more items by selecting one or more pre-configured questions. In further embodiments, pre-configured questions include, by way of non-limiting examples: Do you like this item? Which item to you like best? What can I wear with this item? What accessories will go best with this item? How to I wear this? Does this outfit work? Which product do you like best? Do you have any information about this product? Do these items go together? Which item do you think I should buy? What do you think of this item? Please give me your feedback on this! Which item do you think I should buy? Which item would look best on me? Where can I find nice trendy clothes without spending a lot of money? Where can I buy it? Where can I get the best price? What about the quality? Where can I find the best brand of this item? Should I buy this? Would this look good on me? What do you think of this?

Referring to FIG. 10, in some embodiments, the module adapted to query one or more friends or advisors regarding one or more items from a selection of items is further adapted to display a message to one or more friends or advisors. In some embodiments, the message appears in the web application and/or on the toolbar. In further embodiments, the message appears on a wall or bulletin board. In still further embodiments, the message is appears in an email, an instant message, a SMS, a MMS, a voicemail, or a videoconference. In some embodiments, the message includes a graphic representation of one or more items for purchase. In some embodiments, the message includes a graphic representation or one or more users. In some embodiments, the message includes one or more queries in part or in whole. In some embodiments, the message includes a link to initiate simultaneous viewing of an identical item from said selection of items, such that a live showroom is generated. In some embodiments, the message includes a link to initiate live interaction between two or more users.

Referring to FIG. 12, in some embodiments, the web application includes a module adapted to enable a plurality of users to simultaneously view an identical item from a selection of items, such that a live discussion room is generated. In a particular embodiment, the web application is a social shopping web application includes a module adapted to enable a plurality of users to simultaneously view an identical item for purchase from a selection of items, such that a live shopping showroom is generated. In further embodiments, a live showroom is a web portal application that allows a user to insert or drag any product selected on the web for the purpose of beginning an interactive session. Again, referring to FIG. 12, by dragging items from the right side of the screen to the left side of the screen the item is immediately displayed to all users in a session, or chat room, or community. The users then communicate with one another about the one or more products in the display region (left side of screen).

In some embodiments, either the first user or the second user places an additional item into the live showroom. In some embodiments, the items for purchase are combined in a single graphic representation. In some embodiments, individual graphic representations of items for purchase are grouped together. See FIG. 12. In some embodiments, individual graphic representations of items for purchase are grouped together but not combined into a single graphic representation.

In some embodiments, the first user or the second user uploads a graphic representation (e.g., photograph, illustration, video, etc.) of one or more items already owned (i.e., an owned item) into the live showroom. In some embodiments, the first user or the second user combines the graphic representation of the owned item with the graphic representation of an item for purchase. In some embodiments, the items for purchase are combined in a single graphic representation. In some embodiments, individual graphic representations of items for purchase are grouped together. In some embodiments, individual graphic representations of items for purchase are grouped together but not combined into a single graphic representation).

In some embodiments, the first user or the second user modifies a graphic representation of at least one item for purchase. In some embodiments, the first user or the second user modifies, by way of non-limiting examples, the color of the item for purchase, the size of the item for purchase, combines the item for purchase with an additional item for purchase (e.g., a hat, a belt, a pair of shoes, a scarf, a piece of jewelry, or a purse).

In various embodiments, the web application includes a module adapted to enable a plurality of users to simultaneously view any item of interest (e.g., represented by text, photograph, illustration, video, or a combination of the same) from a selection of items, such that a live discussion room is generated. In further embodiments, a plurality of users to simultaneously read text together. In further embodiments, a plurality of users to simultaneously view a photograph or illustration together. In further embodiments, a plurality of users to simultaneously watch a video together. In some embodiments, the web application is a social learning web application and includes a module adapted to enable a plurality of users to simultaneously view an identical educational item from a selection of items, such that a live classroom is generated. In other embodiments, the web application is a social news web application and includes a module adapted to enable a plurality of users to simultaneously view an identical news item from a selection of items, such that a live discussion room is generated. In other embodiments, the web application is a social travel web application and includes a module adapted to enable a plurality of users to simultaneously view an identical travel arrangement from a selection of arrangements, such that a live discussion room is generated. In other embodiments, the web application is a social dating web application and includes a module adapted to enable a plurality of users to simultaneously view an identical dating profile from a selection of profiles, such that a live discussion room is generated.

In various embodiments, the web application includes a module adapted to enable a plurality of users to exchange items of interest (e.g., represented by text, photograph, illustration, video, or a combination of the same) from a selection of items, such that a live discussion room is generated.

In some embodiments, the social interaction web application comprises a module adapted to enable a first and at least a second user to interact with each other, wherein the interaction includes, by way of non-limiting examples, exchanging emails, chat, or instant messages, sending and receiving SMS, or MMS messages, posting, reading, and replying to blog entries or microblog entries, posting, reading, and replying to BBS posts or wall posts, social networking, screen sharing, video conferencing, VoIP conferencing, and remote access to other user's digital processing devices.

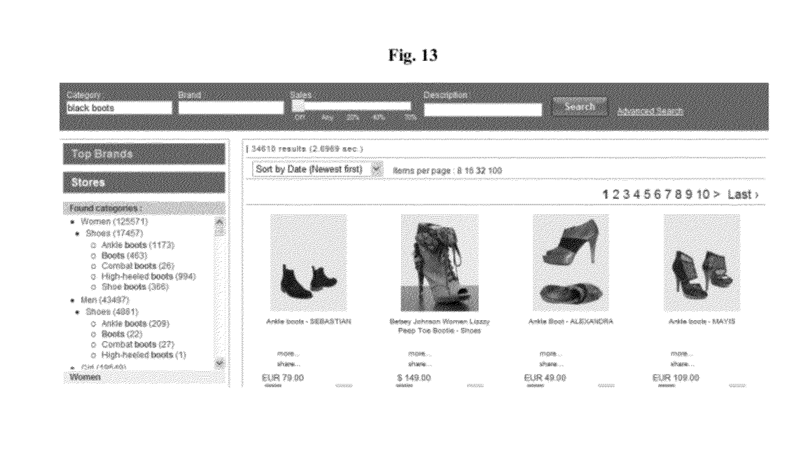

Referring to FIG. 13, in some embodiments, a user searches for an item for purchase, wherein the searching is through a module adapted to search items for purchase provided by the toolbar and/or the web application. In further embodiments, the module searches items previously selected by one or more users from one or more web sites. In some embodiments, the search is by a category selected from: designer, manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof. In some embodiments, the search is by two categories selected from: designer, manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof. In some embodiments, the search is by three categories selected from: designer, manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof. In some embodiments, the search is by four categories selected from: designer, manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof.

### Software Modules

The systems, products, programs, and methods disclosed herein include, in various embodiments, software, server, and database modules. In view of the disclosure provided herein, the software modules are created by techniques known to those of skill in the art using machines, software, and languages known to the art. In some embodiments, the software modules are in one computer program or application. In other embodiments, the software modules are in more than one computer program or application. In various embodiments, the software modules comprise a file, a section of code, a programming object, a programming structure, or combinations thereof. In further various embodiments, the software modules comprise a plurality of files, a plurality of sections of code, a plurality of programming objects, a plurality of programming structures, or combinations thereof. In some embodiments, the software modules are hosted on one machine. In other embodiments, the software modules are hosted on more than one machine. In some embodiments, the software modules are hosted on one or more machines in one location. In other embodiments, the software modules are hosted on one or more machines in more than one location.

### EXAMPLES

The following illustrative examples are representative of embodiments of the systems, products, programs, and methods described herein and are not meant to be limiting in any way.

### Example 1

A first user opens Microsoft® Internet Explorer® on a laptop computer and visits www.select2gether.com. By clicking on a hyperlink, the user downloads an executable application. The executable application installs an explorer bar constituting a social shopping toolbar. The toolbar stays at the bottom of the GUI of the web browser and is available while viewing any web site. The toolbar is optionally and reversibly collapsible and optionally and reversibly removable. The toolbar is part of a larger social shopping networking service and offers features and modules that communicate with a social shopping web application, which is also part of the service. The toolbar includes a module adapted to create a selection of items, wherein said items are selected from one or more web sites, a module adapted to query one or more friends or advisors regarding one or more items from a selection of items, and a module adapted to search previously selected items.

### Example 2

The first user described in Example 1, supra, visits a retail apparel shopping web site and selects a sweater by dragging a hand icon on the toolbar over an image of the sweater and releasing the icon. The image of the sweater is added to the module adapted to create a selection of items. The image of the sweater appears on the toolbar and the URI of the sweater's information is captured by the toolbar. The user then activates a module of the toolbar adapted to query one or more friends or advisors regarding one or more items. The user drags the photo of the sweater to a designated area of the GUI to indicate that the sweater is the subject of the query and the user activates a pull-down menu and selects a pre-configured question; namely, would this look good on me? The user quickly glances at a module of the toolbar adapted to monitor the online status of friends, contacts, and advisors. Seeing that a second user of the system is online, the first user indicates that the second user should receive the query.

### Example 3

The friend described in Example 2, supra, receives an email with an invitation to join a live showroom to view and discuss the sweater. The message includes the photo of the sweater, a photo of the first user, and the text of the query. The second user clicks a hyperlink in the email to enter a social shopping web application including modules adapted to enable simultaneous viewing of an identical item and live interaction between multiple users. The first and second users simultaneously view the sweater and discuss it via instant messaging. The second user uploads a photo of a pair of black shoes that would complement the sweater. The users further discuss the collaboratively forming ensemble.

### Example 4

A first user opens Apple® Safari on an iPhone® and visits the WSJ. The user has previously downloaded and installed an executable mobile application that is a social interacting toolbar. The first user selects a news article of interest and drags the news article to the toolbar. The first user then queries one or more friends regarding the news article.

### Example 5

A first user opens an Android® browser on an Android® phone and visits the IMDB. The user has previously downloaded and installed an executable mobile application that is a social interacting toolbar. The first user selects a movie trailer of interest and drags the trailer to the toolbar. The first user then queries one or more friends regarding the trailer.

### Example 6

A first user opens Internet Explorer® on a desktop computer. The user has previously downloaded and installed a standalone executable application that is a social interacting toolbar. The first user selects a rental house in the Hamptons and drags the house to the toolbar. The first user then queries one or more friends regarding the acceptability of the house as a summer rental.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-based system for social interaction, comprising:
(a) a digital processing device comprising an operating system configured to perform executable instructions and a memory, wherein said processing device is optionally connected to a computer network; and
(b) a computer program including executable instructions that create a social interaction networking service comprising:
i. a social interaction toolbar comprising a module adapted to create a selection of items, wherein said items are selected from one or more web sites; and
ii. a social interaction web application comprising a module adapted to enable at least a first and a second user to simultaneously view an identical item from said selection of items, such that a live showroom is generated, and a module that enables the first and second user to interact with each other.

2. The system of claim 1, wherein said toolbar comprises a functional addition to a web browser or a mobile web browser such as a plug-in, extension, add-in, or add-on.

3. (canceled)

4. The system of claim 1, wherein said toolbar comprises a mobile application.

5. The system of claim 1, wherein said toolbar comprises a standalone application.

6. The system of claim 1, wherein said toolbar is available to a user when viewing any web site.

7. The system of claim 1, wherein said items are text, photographs, videos, hyperlinks, or any combination thereof.

8. The system of claim 1, wherein said items are news articles.

9. The system of claim 1, wherein said items are items for purchase and said interaction is shopping related.

10. (canceled)

11. The system of claim 1, wherein said toolbar further comprises a module adapted to export one or more items from said selection of items to said social interaction web application.

12. The system of claim 1, wherein said toolbar further comprises a module adapted to export one or more items from said selection of items to a third party social network.

13. The system of claim 1, wherein said selection of items comprises graphic representations, such as photographs, of the items.

14. The system of claim 1, wherein said selection of items comprises URIs of the items.

15. The system of claim 1, wherein said module adapted to create a selection of items generates additions to the selection of items by analyzing the previous items selected by a user.

16. The system of claim 1, wherein said toolbar further comprises a module adapted to search items previously selected by one or more users from one or more web sites.

17. The system of claim 1, wherein said toolbar further comprises a module adapted to monitor the online status of one or more friends or advisors.

18. The system of claim 17, wherein said friends or advisors are other users of the social interaction networking service or users of a third party social network.

19. (canceled)

20. The system of claim 1, wherein said toolbar further comprises a module adapted to query one or more friends or advisors regarding one or more items from said selection of items.

21. (canceled)

22. (canceled)

23. Computer readable storage media encoded with a program including instructions executable by the operating system of an optionally networked digital processing device, wherein said instructions create a social shopping networking service comprising:
(a) a social shopping toolbar comprising a module adapted to create a selection of items, wherein said items are selected from one or more web sites; and
(b) a social shopping web application comprising a module adapted to enable at least a first and a second user to simultaneously view an identical item from said selection of items, such that a live showroom is generated, and a module that enables the first and second user to interact with each other.

24. A computer-implemented method for creating a social shopping networking service, comprising:
(a) providing a first user with a computer program including executable instructions that create a social shopping toolbar comprising a module adapted to create a selection of items from one or more web sites; and
(b) providing said first user and at least a second user with a computer program including executable instructions that create a social shopping web application comprising a module adapted to simultaneously view an identical item from said selection of items, such that a live showroom is generated, and a module that enables said users to interact with each other.

25. (canceled)

26. (canceled)

27. The method of claim 24, wherein a user creates a selection of one or more items from one or more web sites by dragging one or more items to an element of said toolbar.

28. (canceled)

29. (canceled)

30. (canceled)

31. (canceled)

32. (canceled)

33. (canceled)
